(19) United States
(12) Patent Application Publication
(10) Pub. No.: US 2008/0065932 A1
(43) Pub. Date: Mar. 13, 2008

(54) IMAGE FORMING APPARATUS

(76) Inventors: Kenji Izumiya, Tokyo (JP); Yumiko Higashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/839,327

(22) Filed: Aug. 15, 2007

(30) Foreign Application Priority Data
Sep. 13, 2006 (JP) JP2006-248380

(51) Int. Cl. G06F 11/22

(52) U.S. Cl. 714/40; 714/E11.148

(57) ABSTRACT

An image forming apparatus including: a registration section which registers information on a diagnostic mode, where an operation mode to diagnose inside the image forming apparatus based on error information is assumed to be the diagnostic mode; an error detecting section which detects an error in the apparatus and outputs error information; and a control section which, when the error detecting section outputs error information, receives the information on the diagnostic mode corresponding to the error information from the registration section, and executes problem solution and recovery of the apparatus.

### CROSS REFERENCE TO RELATED APPLICATION

The present application is based on Japanese Patent Application No. 2006-248380 filed with Japan Patent Office on Sep. 13, 2006, the entire content of which is hereby incorporated by reference.

### BACKGROUND OF THE INVENTION

1. Field of Technology

The present invention relates to an image forming apparatus that can be applied to a color printer or a color copier provided with a self-diagnostic function and to a color multifunctional peripheral having a combination of their functions.

2. Description of Related Art

In recent years, there has been an increasing use of a color printer, color copier and color multifunctional peripheral having a combination of their functions. To maintain the optimum color image printing quality (color reproducibility), the color image forming apparatus of this type is designed to ensure that the yellow (Y), magenta (M), cyan (C) and black (BK) colors for reproducing the R, G, and B colors of the document image are superimposed on the intermediate transfer belt. To ensure superimposition of the Y, M, C and BK colors with satisfactory reproducibility, this color image forming apparatus is provided with a device for monitoring each portion in the image forming unit. When an error has been detected by this monitoring device, the self-diagnostic function is utilized to adjust the image forming unit to the proper status.

With respect to the color copier having the aforementioned self-diagnostic function, Unexamined Japanese Patent Application Publication No. H10-301800 (JPA10-301800) discloses a maintenance system of multi-function image processing peripheral equipment, maintenance system of computer peripheral equipment and maintenance method thereof. In these maintenance systems, a maintenance script file is created at a service depot. This file is downloaded to the personal computer (PC) of a user as desired, and the items specified in the script file is executed for the multi-functional image peripheral equipment (MFP) connected to the PC. Then the result of diagnosis is sent back to the PC. Such a maintenance system is aimed to allow the user to maintain the multi-function image processing peripheral equipment easily under remote control.

Unexamined Japanese Patent Application Publication No. 2005-077690 (JPA2005-077690) discloses the image forming apparatus and its operation verification method. This image forming apparatus is equipped with a control device which provides control in such a way as to allow an image forming device to execute a plurality of operations sequentially in response to the check items having been selected, at the time of verifying the operation of the image forming apparatus having a plurality of functions. The diagnostic result obtained from the self-diagnosis made by this control device is outputted for each check item. This arrangement is aimed to ensure the verification of the apparatus to be conducted by the apparatus itself with high speed and high precision.

Unexamined Japanese Patent Application Publication No. 2005-172902 (JPA2005-172902) proposes an image forming system. In this image forming system, maintenance items are displayed on the display section of a liquid crystal display screen, when the image forming apparatus of a copier or the like is to be maintained. A maintenance guidance prepared according to the level of the operator's skill is displayed on the display section on a selective basis. This system arrangement is aimed to ensure easy and efficient maintenance conforming to the level of each operator.

The color image forming apparatus according to the conventional method involves the following problems:

(i) Generally, a mode for diagnosing the error of the image forming device is provided. When an error has occurred, troubleshooting (problem solution or recovery work) is executed inside the system. However, location of an error is getting more and more difficult as a result of growing sophistication of the system.

(ii) In the maintenance system disclosed in JPA10-301800, the multi-function image processing peripheral equipment is operated by a remote management tool, whose function, however, is restricted to mere diagnosis of predetermined items. Thus, a new diagnostic item which has been considered as essential cannot be checked, and problem solution is anticipated to require much time.

(iii) In the image forming apparatus as disclosed in JPA2005-077690, an error is determined and an error part is specified by sequential diagnosis of the charging, exposure, development and cleaning process modules. However, this technological level has not yet reached the engineering concept including editing of the inspection sequence or diagnostic items.

(iv) In the image forming system proposed in JPA2005-172902, in response to the level of the operators' skill, the contents of the maintenance guidance are changed and diagnostic items are displayed. The check item and check sequence are based on the experience (know-how) of each operator, and therefore, great variations are anticipated to occur in the time from the occurrence of a problem to the solution thereof.

The object of the present invention is to solve the aforementioned problems and to provide an image forming apparatus wherein troubleshooting can be provided predominantly under the initiative of said apparatus and, at the same time, troubleshooting of said apparatus can be executed in the diagnostic mode edited and registered in conformity to said apparatus.

### SUMMARY

To solve the aforementioned problems, the image forming apparatus reflecting one aspect of the present invention includes: a registration section for registering the information on diagnostic mode when the operation of diagnosis inside the apparatus based on the error information is placed in the diagnostic mode; an error detecting section for detecting an error in this apparatus and outputting the error information; and a control section that allows error information to be inputted from this error detecting section, receives the information on the diagnostic mode corresponding to this error information from the registration section, and executes the problem solution and recovery of the apparatus.

### BRIEF DESCRIPTION OF THE DRAWINGS

These and other objects, advantages and features of the invention will become apparent from the following description thereof taken in conjunction with the accompanying drawings in which:

FIG. 1 is a conceptual diagram showing the structure example of a color copier 100 as an embodiment of the present invention;

FIG. 2 is a block diagram representing the internal structure example of the control system of the color copier 100;

FIG. 3 is a data format showing the structure example of the diagnostic data Dx;

FIG. 4 is a diagram showing the storage example of the diagnostic data Dx in NVRAM33;

FIGS. 5 (A) and (B) are drawings showing the display examples of an error code selection screen P11 and a registration item selection screen P12;

FIGS. 6 (A) and (B) are drawings showing the display example of a diagnostic mode selection (Registration 2) screen P21 and a diagnostic content input screen P22 thereof in error [0123];

FIGS. 7 (A) and (B) are diagrams showing the display example of a registration setting screen P31 and a Setting Content Confirmation Screen P32 in the error [0123]:

FIG. 8 is a flow chart representing an example of registering the diagnostic mode (part 1);

FIG. 9 is a flow chart representing an example of registering the diagnostic mode (part 2);

FIG. 10 is a flow chart representing an example of registering the diagnostic mode (part 3);

FIG. 11 is a flow chart representing an example of registering the diagnostic mode (part 4);

FIG. 12 is a flow chart representing an example of registering the error xxxx diagnostic procedure (part 1);

FIG. 13 is a flow chart representing an example of registering the error xxxx diagnostic procedure (part 2);

FIG. 14 is a flow chart representing an example of registering the error xxxx diagnostic procedure (part 3);

FIGS. 15 (A) and (B) are diagrams showing the display examples of an error occurrence notice screen P41 and a password input screen P42;

FIGS. 16 (A) and (B) are diagrams showing the display examples of a diagnostic mode (error 0123) function startup screen P51 and under-diagnosis of I/O function screen P52;

FIGS. 17 (A) and (B) are diagrams showing the display examples of a I/O function diagnostic result screen P61 and under-diagnosis of image forming process screen P62;

FIGS. 18 (A) and (B) are diagrams showing the display examples of image forming process check result screen P71 and gamma curve under-readjustment screen P72;

FIG. 19 is a flow chart showing an example of processing in execution of diagnostic mode (part 1) in the color copier 100; and

FIG. 20 is a flow chart showing an example of processing in execution of diagnostic mode (part 2) in the color copier 100.

### DETAILED DESCRIPTION OF THE PREFERRED EMBODIMENT

Referring to drawings, the following describes the image forming apparatus as an embodiment of the present invention:

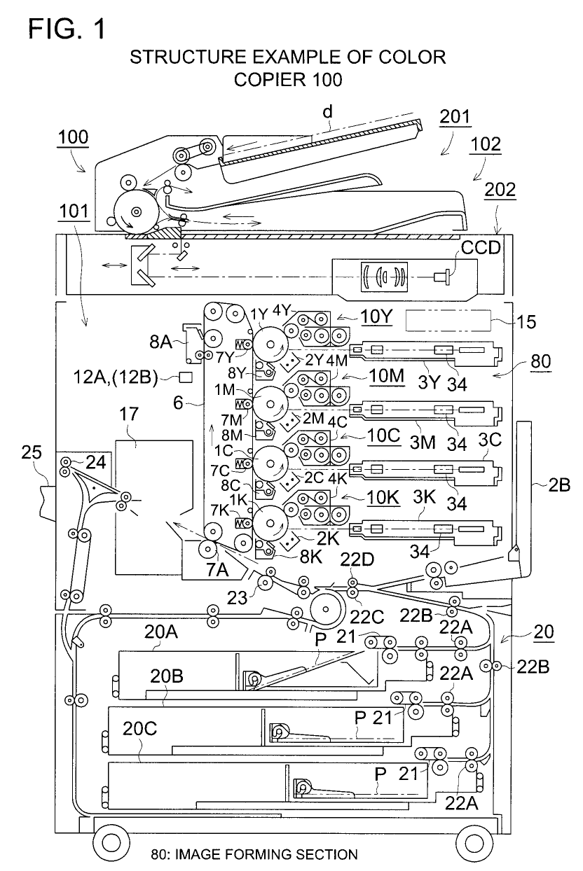

FIG. 1 is a conceptual diagram showing the structure example of a color copier 100 as an embodiment of the present invention.

The color copier 100 shown in FIG. 1 constitutes an example of the image forming apparatus. It is provided with a problem solution and recovery function, and solves the problem and recovers the system according to the diagnostic mode when an error has occurred inside this copier 100. The diagnostic mode in the sense in which it is used here refers to the self-diagnostic operation inside the copier based on the error information detected in the copier 100.

The color copier 100 is made up of a copier body 101 and scanner section 102. The scanner section 102 is mounted on the upper portion of the copier body 101, and is made of an automatic document sheet feed apparatus 201 and document image scanning exposure apparatus 202. The document d placed on the document platen of the automatic document sheet feed apparatus 201 is conveyed by a conveyance device (not illustrated). The image on one side or both sides of the document is scanned and exposed to light by the optical system of the document image scanning exposure apparatus 202, and the incident light reflecting the document image is read by a line image sensor CCD.

The analog image signal having been subjected to photoelectric conversion by the line image sensor CCD undergoes analog processing, analog-to-digital conversion, shading correction and image compression processing in the image processing section (not illustrated), and is formed into digital image information. The image information is then sent to an image forming section 80. The image forming section 80 includes a plurality of sets of image forming units 10Y, 10M, 10C and 10K containing image carries for colors Y, M, C and K; an endless intermediate transfer belt 6; a sheet feed conveyance device containing an automatic sheet re-feed mechanism (ADU mechanism); and a fixing apparatus 17 for fixing a toner image in position.

In this example, the image forming unit 10Y has a photoreceptor drum 1Y, charging device 2Y, writing unit 3Y, development unit 4Y, and image forming member cleaning section 8Y, whereby a yellow (Y) image is formed. The photoreceptor drum 1Y constitutes an example of an image carrier, and is arranged rotatably, for example, in the vicinity of the upper right side of the intermediate transfer belt 6 so that the Y-color toner image is formed. In this example, the photoreceptor drum 1Y is turned in the counterclockwise direction by a drive mechanism (not illustrated). A charging device 2Y is arranged obliquely to the lower right of the photoreceptor drum 1Y, and is used to charge the surface of the photoreceptor drum 1Y at a predetermined potential.

A writing unit 3Y having a laser light source and polygon mirror 34 is provided just beside the photoreceptor drum 1Y face to face with each other. This unit applies the lazer beam having a predetermined intensity based on the Y-color image data, to the preciously charged photoreceptor drum 1Y.

The laser beam is used, for example, to write the Y-color image data in the main scanning direction by deflection scanning through rotation of a Y-color polygon mirror 34. The main scanning direction is parallel to the rotary axis of the photoreceptor drum 1Y. The photoreceptor drum 1Y is rotated in the sub-scanning direction. The sub-scanning direction is perpendicular to the rotary axis of the photoreceptor drum 1Y. The photoreceptor drum 1Y rotates in the sub-scanning direction, and Y-color electrostatic latent image is formed on the photoreceptor drum 1Y by deflection scanning of the laser beam in the main scanning direction.

A development unit 4Y is arranged above the writing unit 3Y, and is used to develop the Y-color electrostatic latent image formed on the photoreceptor drum 1Y. The development unit 4Y includes an Y-color development roller (not illustrated). The development unit 4Y incorporates an Y-color toner agent and a carrier.

The Y-color development roller incorporates a magnet and rotates to send the two-component developer obtained by agitation of the carrier and Y-color toner agent in the development unit 4Y, to the position opposite the photoreceptor drum 1Y, so that the electrostatic latent image is developed by the Y-color toner agent. The Y-color toner image formed on this photoreceptor drum 1Y is transferred to the intermediate transfer belt 6 by the operation of a primary transfer roller 7Y (primary transfer). A cleaning section 8Y is arranged below on the left of the photoreceptor drum 1Y to remove (clean off) the toner remaining on the photoreceptor drum 1Y after the previous writing operation.

In this example, an image forming unit 10M is arranged below the image forming unit 10Y. The image forming unit 10M includes a photoreceptor drum 1M, charging device 2M, writing unit 3M, development unit 4M and image forming member cleaning section 8M so as to form a magenta (M) image. An image forming unit 10C is arranged below the image forming unit 10M. The image forming unit 10C has a photoreceptor drum 1C, charging device 2C, writing unit 3C, development unit 4C and image forming member cleaning section 8C so that the cyan (C) image is formed.

An image forming unit 10K is provided below the image forming unit 10C. The image forming unit 10K includes a photoreceptor drum 1K, charging device 2K, writing unit 3K, development unit 4K and image forming member cleaning section 8K so that a black (BK) image can be formed. The organic photoreceptors (Organic Photo Conductor: OPC) drums are employed as photoreceptor drums 1Y, 1M, 1C and 1K

The functions of the members constituting the image forming units 10M through 10K are assigned with the same reference numerals as those of the image forming unit 10Y if their functions are the same, except that “Y” should be replaced by “M”, “C” or “K”, and therefore, they will not be described to avoid duplication. The primary transfer bias voltage with a polarity (positive in this Example) reverse to that of toner particles to be used is applied to the aforementioned primary transfer rollers 7Y, 7M, 7C and 7K.

ON the intermediate transfer belt 6 a color image is formed by superimposition of the toner images transferred by the primary transfer rollers 7Y, 7M, 7C and 7K. The color image formed on the intermediate transfer belt 6 is fed toward the secondary transfer roller, for example, by the counterclockwise rotation of the intermediate transfer belt 6. The secondary transfer roller 7A is located below the intermediate transfer belt 6 to ensure that the color toner image formed on the intermediate transfer belt 6 is collectively transferred (secondary transfer) onto the paper P fed from the sheet feed section 20.

The sheet feed section 20 is arranged, for example, below the aforementioned writing unit 3K, and is provided with sheet feed trays 20A, 20B and 20C. The paper P incorporated in the sheet feed trays 20A, 20B and 20C is fed by a feed-out roller 21 and sheet feed roller 22A provided on each of the sheet feed trays 20A, 20B and 20C, and is brought to the secondary transfer roller 7A through the conveyance rollers 22B, 22C and 22D, registration roller 23 and others.

A fixing apparatus 17 is installed on the left side of the secondary transfer roller 7A to apply a process of fixing to the paper P with the color image transferred thereon. The fixing apparatus 17 has a fixing roller, pressure roller and heater (1H). In the process of fixing, the paper P is passed through the fixing roller and pressure roller heated by the heater, whereby the aforementioned paper P is heated and pressed. The paper P having been subjected to the process of fixing is sandwiched between the sheet ejection rollers 24 and is placed on the sheet ejection tray 25 located outside the machine.

In this example, a cleaning section 8A is mounted above the left side of the intermediate transfer belt 6 to remove the toner remaining on the intermediate transfer belt 6 subsequent to transfer. The cleaning section 8A contains a discharger for discharging the intermediate transfer belt 6, and a pad for removing toner remaining on the intermediate transfer belt 6. After the belt surface is cleaned by this cleaning section 8A and the intermediate transfer belt 6 has been discharged by the discharger, the intermediate transfer belt 6 enters the next image forming cycle. This allows a color image to be formed on paper P.

The copier body 101 has a control section 15, which solves problems according to the diagnostic mode when an error has been detected inside the aforementioned copier 100, whereby the machine is recovered to the normal state.

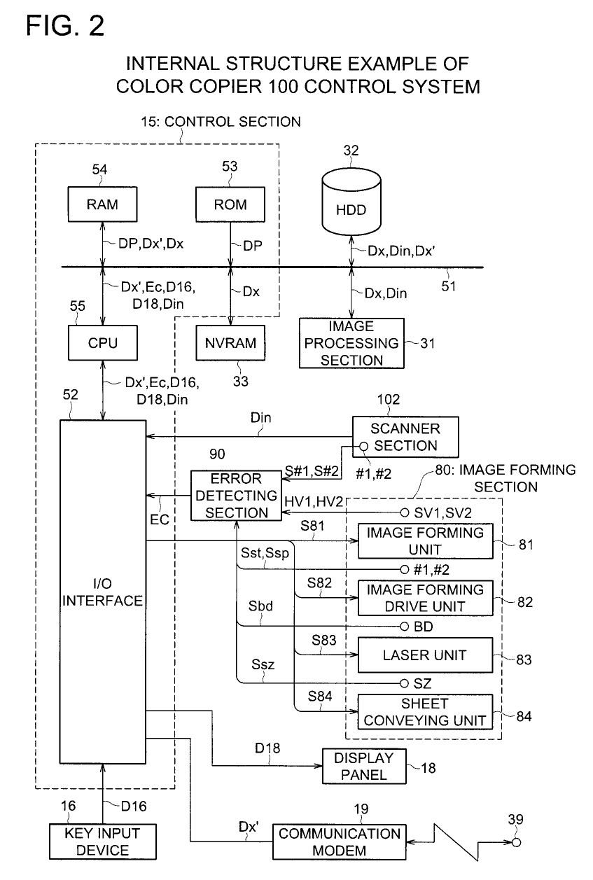

FIG. 2 is a block diagram representing the internal structure example of the control system of the color copier 100. The color copier 100 of FIG. 2 includes a control section 15, key input device 16, display panel 18, communication modem 19, image processing section 31, hard disk apparatus (hereinafter referred to as “HDD32”), NVRAM33 (Non-Volatile Random Access Memory), image forming section 80 and scanner section 102.

The control section 15 has a system bus 51. The system bus 51 is connected, for example, with a ROM (Read Only Memory) 53, RAM (Random Access Memory) 54, CPU (Central Processing Unit) 55, image processing section 31, HDD32 and NVRAM33.

The ROM53 stores the system program data Dp for overall control of the aforementioned copier. The RAM54 is used as a work memory. For example, it temporarily stores the control command at the time of executing the diagnostic mode. When the CPU 55 is turned on, the system program data Dp is read from the ROM 53 to the RAM 54 to start the system, and the aforementioned copier as a whole is controlled based on the operation data D16 from the key input device 16.

The CPU 55 is connected with an I/O interface 52. The I/O interface 52 is connected with the key input device 16 constituting an example of the input section so that the diagnostic mode information (hereinafter referred to as “diagnostic program DPx”) is edited and/or registered into the NVRAM33. The key input device 16 is used when error information (hereinafter referred to as “error code EC”), registration number or diagnostic item number is selected, or when the diagnostic contents thereof are set. The diagnostic contents include the type of diagnosis, object of diagnosis and judgment threshold. The NVRAM33 constitutes an example of the storage section and stores the diagnostic data Dx. The diagnostic data Dx is made of an error code EC and diagnostic program DPx.

In this example, the key input device 16 and NVRAM33 constitute an example of the registration section and is used to register at least the diagnostic program DPx corresponding to the error code EC. The diagnostic program DPx is a program to solve the problem and recovers the system when an error has occurred inside this copier 100. This program provides self-diagnosis inside the copier based on the error code EC detected by the aforementioned copier 100.

The contents thereof include the description of:

a step of receiving the registration of the data on the diagnostic program DPx;

a step of detecting an error inside the aforementioned copier and outputting the error code EC; and

a step of inputting the error code EC, reading the data on the diagnostic program DPx corresponding to the aforementioned error code EC from the NVRAM33, and executing the process of problem solution and recovering the copier 100 to the normal state based on the data on diagnostic program DPx.

The diagnostic program DPx can be stored in the HDD32 without the storage position being restricted to the NVRAM33. In any case, the diagnostic program DPx is stored associated with the diagnostic mode and the relevant error code EC. The image data Din obtained by reading the document d at the time of normal image forming operation is stored in the HDD32 through the control section 15. It is also possible to arrange such a configuration that the HDD32 also stores the image data obtained by reading the diagnostic test pattern at the time of registration of the diagnostic mode.

At the time of edition and/or registration, the data, obtained from the operation of the key input device 16, for creating the diagnostic program DPx is outputted to the CPU 55 as the operation data D16. The user operates the key input device 16 and edits the information on correlation between error factors. For example, the user edits the diagnostic items for troubleshooting or diagnostic sequence. This is intended to ensure efficient debugging operation.

The aforementioned system bus 51 is connected with an image processing section 31 in addition to the ROM 53, RAM 54 and CPU 55. And the image processing section 31 executes image processing based on the operation data D16 outputted from the key input device 16 operated by the user, when editing the information on the correlation between error factors. For example, it creates the display data D18 required for display on the diagnostic mode registration screen and diagnostic mode execution screen.

In this example, when the user operates the key input device 16 and the order of priority is set to the diagnostic mode at the time of diagnostic mode registration, the control section 15 implements the diagnostic mode according to this order of priority at the time of executing the diagnostic mode. In this arrangement, the order of priority is set. This is because effective diagnosis of the test object and earlier problem solution can be ensured in some cases if the aforementioned registration item is executed in preference to many other registration items.

The control section 15 is inputted error code EC from the error monitoring system for administering the sensor outputs at the time of error detection, reads the diagnostic program DPx corresponding to the aforementioned error code EC from the NVRAM33 at the time of diagnostic mode, and solves the problem of the aforementioned copier 100 and recover the copier in the normal state upon receipt of this program.

Without being restricted to the time of edition and/or registration, the aforementioned key input device 16 can also be used when designating the sheet size and sheet feed tray, or setting the image forming conditions such as printing density or the number of copies. The data for such setting is also outputted to the CPU 55 as operation data D16.

The image forming section 80 for forming an image under the aforementioned image forming conditions includes an image forming unit 81, image forming drive unit 82, laser unit 83 and sheet conveying unit 84.

The image forming unit 81 is made up of photoreceptor drums 1Y, 1M, 1C and 1K for various colors as shown in FIG. 1, charging devices 2Y, 2M, 2C and 2K, development units 4Y, 4M, 4C and 4K, an intermediate transfer belt 6, cleaning sections 8Y, 8M, 8C and 8K, and a fixing apparatus 17. In connection with the charging devices 2Y, 2M, 2C and 2K, the image forming unit 81 is provided with an LED for discharging, whereby the photoreceptor drum 1Y and others are discharged. The image forming unit 81 is operated in response to the image forming control signal S81. The image forming control signal S81 is supplied from the CPU 55 through the I/O interface 52.

The image forming unit 81 is provided with voltage detecting sensors (potential sensors) SV1 and SV2, for example. The sensor SV1 detects high voltage for charging and outputs the voltage detection signal HV1 to the error monitoring system. The sensor SV2 detects high voltage for transfer and outputs the voltage detection signal HV2 to the error monitoring system. The voltage detection signal HV1 is a signal obtained by detecting −1000V, for example. The voltage detection signal HV2 is a signal obtained by detecting +100V, for example.

The image forming unit 81 is provided with a patch detection sensor (not illustrated) and toner density sensor in addition to the aforementioned sensors SV1 and SV2. The image density signal obtained by detection of patch density and toner density is outputted to the error monitoring system.

The image forming drive unit 82 includes a motor and a clutch for driving an image forming unit 81. The image forming drive unit 82 operates according to the image forming drive signal S82. The image forming drive signal S82 is supplied from CPU 55 through the I/O interface 52, for example. The image forming drive unit 82 is provided with a photoreceptor drive motor M1 and development unit driving motor M2 (neither is illustrated), as well as a cleaner drive clutch CL1.

The image forming drive unit 82 is provided with a timing detection sensor #1, which detects the timing of the motor drive and outputs the timing detection signal Sst to the error monitoring system. Further, a position detecting sensor #2 is provided to detect the position of the clutch and outputs the position detecting signal Ssp to the error monitoring system.

The laser unit 83 is made up of the writing units 3Y, 3M, 3C and 3K for various colors including a laser light source (not illustrated) and the polygon mirror 34 shown in FIG. 1. The laser unit 83 operates in response to the laser drive signal S83. Similarly, the laser drive signal S83 is supplied to the CPU 55, for example, through the I/O interface 52. The laser unit 83 is equipped with a beam detecting sensor BD, and outputs the beam detection signal Sbd to the error monitoring system.

The sheet conveying unit 84 includes a motor, a clutch for driving the sheet feed section 20 including the sheet feed trays 20A, 20B and 20C shown in FIG. 1 and others. The sheet conveying unit 84 operates in response to the sheet conveyance control signal S84. Similarly, the sheet conveyance control signal S84 is supplied from the CPU 55 through the I/O interface 52.

The sheet conveying unit 84 contains a sheet feed motor and sheet feed clutches CL1 and CL2. It also includes a sheet size detecting sensor SZ. Detecting the sheet size, it outputs the paper detection signal Ssz to the error monitoring system.

The scanner section 102 transfers the image data Din obtained by reading the document d to the HDD32 through the control section 15. The scanner section 102 includes a scanner motor, exposure lamp, sensor #1 for detecting the scanning timing of the document reading optical system and sensor #2 for detecting the home position thereof. These sensors #1 and #2 output the optical system detection signals S#1 and S#2 to the error monitoring system.

The aforementioned I/O interface 52 is connected with an error detecting section 90 constituting the error monitoring system. Detecting the errors of the image forming unit 81, image forming drive unit 82, laser unit 83 and sheet conveying unit 84, for example, it outputs the error code EC to the CPU 55. A CPU or MPU (Micro Processing Unit, neither is illustrated) is used as the error detecting section 90. In this example, the CPU 55 can be used to serve as the error detecting section 90.

The error detecting section 90 is connected with the sensors SV1, SV2, #1, #2 and SZ provided on each of the image forming unit 81, image forming drive unit 82, laser unit 83 and sheet conveying unit 84. In the error detecting section 90, various types of detection signals S#1, S#2 and others, the voltage detection signal HV1, HV2, the timing detection signal Sst, position detection signal Ssp, beam detection signal Sbd, sheet detection signal Ssz obtained from the sensors SV1, SV2, #1 and #2, beam detecting sensors BD and sensor SZ are compared with the expected values for various types of signals set in advance. Then the error detecting section 90 determines if these signals contain an error or not.

If the detection signals S#1, S#2, HV1, HV2, Sst, Ssp, Sbd, Ssz and others fail to meet the expected values, the error detecting section 90 determines that the aforementioned unit is in the state of “error”, and sends the error code EC to the CPU 55. This arrangement ensures the error detecting section 90 to implement a centralized management of the sensor output.

The I/O interface 52 is connected with a display panel 18 constituting an example of the display section, which displays the result of diagnostic mode registration or the result of executing the diagnostic mode. For example, based on the display data D18, the display panel 18 displays the diagnostic mode registration screen and diagnostic mode execution screen. The display data D18 is supplied from the CPU 55 through the I/O interface 52 at the time of diagnostic mode registration and execution of the diagnostic mode. The display panel 18 is made up of a touch panel and a liquid crystal display apparatus, for example, and the operation panel of GUI (Graphic User Interface) system is used.

The I/O interface 52 is connected with a communication modem 19 constituting an example of the communication section. The communication modem 19 can be connected with the network 39, and the diagnostic data Dx′=(EC+DPx) send from the server (at external service depot) (not illustrated) is received from the network 39. This arrangement allows the most updated diagnostic program DPx to be downloaded from a predetermined service depot through the communication modem 19. The service depot is provided with information processing apparatuses such as a server and an image forming apparatus.

When the diagnostic data Dx′=(EC+DPx) registered in the NVRAM33 or HDD32 has been updated, the registration contents are sent (notified) to a predetermined service depot through the communication modem 19 and network 39. This arrangement allows the diagnostic program DPx of updating to be sent from the service depot to another copier or multifunctional peripheral via the network 39 and communication modem 19. Thus, the diagnostic program DPx of updating can be shared among a plurality of copiers and multifunctional peripherals connected to the network 39. The network 39 includes the Internet, public telephone line and leased line.

The aforementioned control section 15 updates the diagnostic mode registered in the NVRAM33 based on the diagnostic program DPx received through the communication modem 19. Thus, troubleshooting can be implemented in the diagnostic mode updated by the diagnostic mode update function of the color copier 100 linked to the network, and debugging can be performed with high efficiency. This feature is provided by the color copier 100 equipped with the troubleshooting (problem solution and recovery) function.

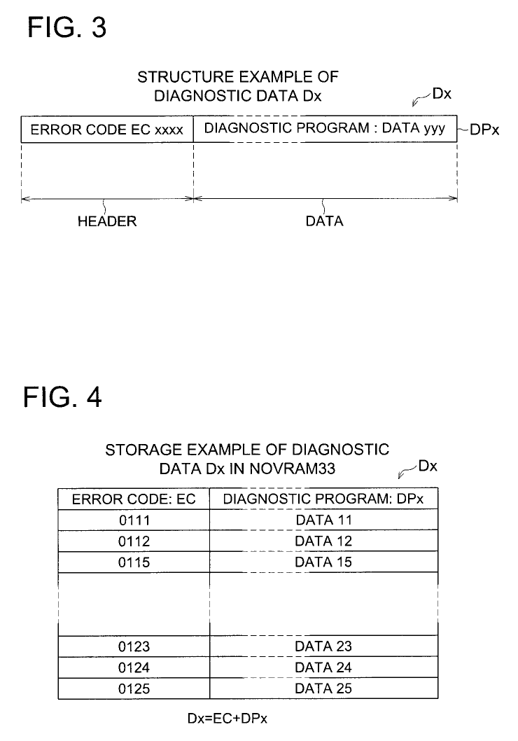

FIG. 3 is a data format showing the structure example of the diagnostic data Dx. In the data format of FIG. 3, the diagnostic data Dx (=EC+DPx) is assigned with the header area and data area. The header area contains the description of the error code EC (xxxx). The data area includes the description of the data (DATA yyy) constituting the diagnostic program DPx. This is intended to ensure that, when an error has occurred, the CPU 55 can apply the diagnostic mode to the image forming unit 81, image forming drive unit 82, laser unit 83 and sheet conveying unit 84 with which the error code EC are diagnostic program DPx are related.

FIG. 4 is a diagram showing the storage example of the diagnostic data Dx in NVRAM33. The storage example of the diagnostic data Dx of FIG. 4 is provided with a column for the description of the error code and diagnostic program DPx.

The data=“DATA11” constituting the diagnostic program DPx is stored to support the error code “0111”. Similarly, data=“DATA12” is stored to support the error code “0112”; data=“DATA15” is stored to support the error code “0115”; . . . data=“DATA22” is stored to support the error code “0122”; data=“DATA23” is stored to support the error code “0123”; data=“DATA24” is stored to support the error code “0124”; and data=“DATA25” is stored to support the error code “0125”. Thus, the data constituting the diagnostic program DPx can be read out using the error code EC as an address.

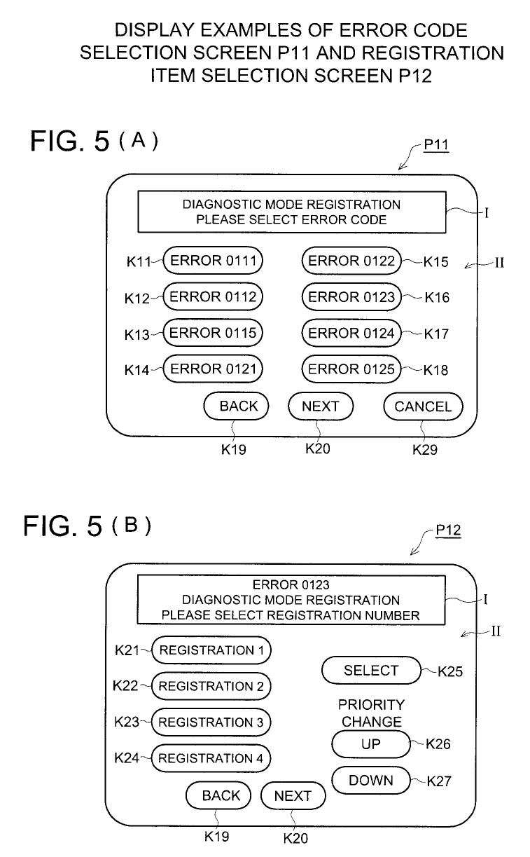

FIGS. 5 (A) and (B) are drawings showing the display examples of an error code selection screen P11 and a registration item selection screen P12.

The error code selection screen P11 in FIG. 5 (A) is displayed on the aforementioned display panel 18 when the “DIAGNOSTIC MODE REGISTRATION MENU” is selected on the menu selection screen (not illustrated) of the display panel 18 of FIG. 2. An key input icon is indicated on the display panel 18. The icon keys are operated by the touch panel of the display panel 18. The icon keys can be operated by using the key input device 16.

In the display panel 18, the error code selection screen P11 is divided into two areas—a message display area (hereinafter referred to as “message area I”) and an icon key display area (hereinafter referred to as “key input area II”).

The message, “Diagnostic mode Registration: Please select error code EC”, appears in the message area I. In the key input area II, the icon key K11 of the error code “0111”, the icon key K12 of the error code “0112”, the icon key K13 of the error code “0115” and the icon key K14 of the error code “0121” are displayed on the left side of the screen. The icon key K15 of the error code “0122”, the icon key K16 of the error code “0123”, the icon key K17 of the error code “0124” and the icon key K18 of the error code “0125” are displayed on the right side.

The “BACK” icon key K19 and “NEXT” icon key K20 are displayed below the icon key K14 and icon key K18. When the icon key K19 is pressed (selected), the menu selection screen reappears on the display. When the icon key K20 is pressed, display is updated from the error code selection screen P11 to a screen of the lower order, for example, the registration item selection screen P12.

The “CANCEL” icon key K29 is displayed adjacent to the icon key K20. When the icon key K29 is pressed, the object error code EC selected on the error code selection screen P11 is returned to the unselected state. This arrangement allows the object error code EC to be selected or not selected on the error code selection screen P11 at the time of registration of the diagnostic mode.

For example, when the icon key K16 of the error code “0123” is selected on the error code selection screen P11 of FIG. 5 (A), display is switched to the registration item selection screen P12 of FIG. 5 (B). The registration item selection screen P12 is displayed on the display panel 18 of FIG. 2.

The message area I and key input area II of the error code 0123 are separately displayed on the registration item selection screen P12 of FIG. 5 (B). The message, “Error 0123 Diagnostic Mode Registration: Please select the Registration Number” is displayed in the message area I.

In this example, the icon key K21 of “Registration 1”, the icon key K22 of “Registration 2”, the icon key K23 of “Registration 3” and the icon key K24 of “Registration 4 are displayed in the key input area II in that order, starting sequentially from the upper left of the screen. When the icon key K21 is pressed, “Registration NUMBER 1” is selected. When the icon key K22 is pressed, “Registration NUMBER 2” is selected. When the icon key K23 is pressed, “Registration NUMBER 3” is selected. When the icon key K24 is pressed, “Registration NUMBER 4” is selected.

The “SELECT” icon key K25, PRIORITY CHANGE “UP” icon key K26, and “DOWN” icon key K27 are displayed in the key input area II in that order, starting sequentially from the upper right of the screen. If the icon key K25 is pressed, selection of the “Registration NUMBER” can be confirmed. If the icon key K26 is pressed, a higher is given to the priority in registration number selection. If the icon key K27 is pressed, a lower is given to the priority in registration number selection.

Similarly to the case of the error code selection screen P11, the “BACK” icon key K19 and “NEXT” icon key K20 are displayed below the icon key K24 and others. This arrangement allows the registration number to be selected on the registration item selection screen P12 at the time of diagnostic mode registration.

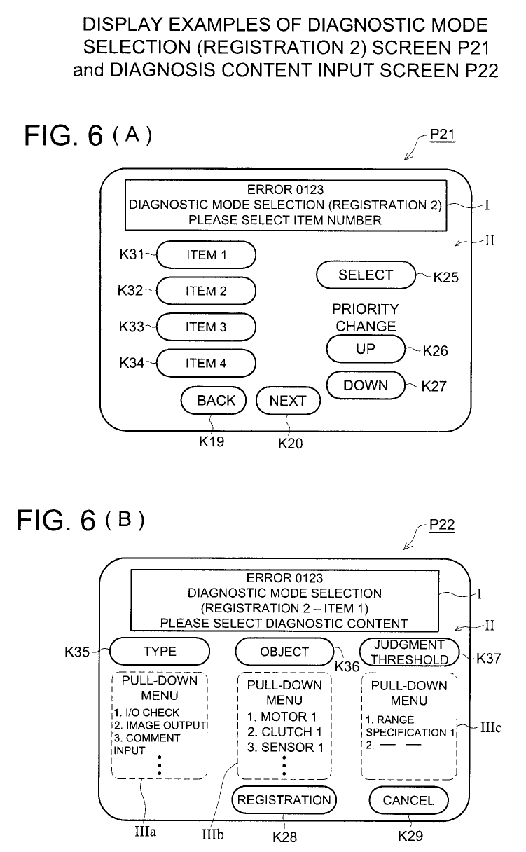

FIGS. 6 (A) and (B) are drawings showing the display example of a diagnostic mode selection (registration 2) screen P21 and a diagnostic content input screen P22 thereof in error [0123].

When the registration number “2” icon key K22 is selected on the registration item selection screen P12 of FIG. 5 (B) and the “SELECT” icon key K25 is pressed, display is switched to the diagnostic mode selection (registration 2) screen P21 of FIG. 6 (A). The diagnostic mode selection (registration 2) screen P21 is displayed on the display panel 18 of FIG. 2.

The message area I and key input area II of the error code 0123 are separately displayed on the diagnostic mode selection (registration 2) screen P21 of FIG. 6 (A). The message, “ERROR 0123; Diagnostic Mode Selection (Registration 2); Please select Item Number” appears in the message area I.

The “ITEM 1” icon key K31, “ITEM 2” icon key K32, “ITEM 2” icon key K33, and “ITEM 4” icon key K34 appear in the key input area II on the left side of the screen. When the icon key K31 is pressed, the “ITEM 1” is selected. When the icon key K32 is pressed, the “ITEM 2” is selected. When the icon key K33 is pressed, the “ITEM 3” is selected. When the icon key K34 is pressed, the “ITEM 4” is selected.

The “SELECT” icon key K25, PRIORITY CHANGE “UP” icon key K26, and “DOWN” icon key K27 described with reference to the registration item selection screen P12 appear on the right side of the screen in the key input area II. The “BACK” icon key K19 and “NEXT” icon key K20 are displayed below the icon key K34 and others. This arrangement allows the item number to be selected on the diagnostic mode selection (registration 2) screen P21 at the time of diagnostic mode selection.

For example, when the “ITEM 1” icon key K32 is selected on the diagnostic mode selection (registration 2) screen P21 of FIG. 6 (A), the display is switched to the error [0123] diagnostic mode selection (registration 2) screen P21 of FIG. 6 (B). The diagnostic content input screen P22 appears on the display panel 18 of FIG. 2.

The error code 0123 message area I, key input area II and input content display area IIIa through IIIc are separately displayed on the diagnostic content input screen P22 of FIG. 6 (B). The message, “INPUT THE ERROR 0123 DIAGNOSTIC MODE SELECTION (REGISTRATION—ITEM 1) DIAGNOSTIC CONTENT” appears in the message area I.

In the key input area II, the “Type” icon key K35 is displayed on the left of the screen. The input item is displayed in the input content display area IIIa located below. The “1. I/O Check, 2. Image Output, 3. Comment Input . . . ” together with the “pull-down menu” character information is displayed as an input item.

In the key input area II, the “Object” icon key K36 is displayed at the center of the screen. An input item is displayed on the input content display area IIIb located below. The “1. Motor 1, 2. Clutch 1, 3. Sensor 1 . . . ” together with the “pull-down menu” character information is displayed as an input item.

In the key input area II, the “Judgment Threshold” icon key K37 is displayed on the right of the screen. The “1. Range Specification 1, 2.— . . . ” together with the “pull-down menu” character information is displayed below as the input item.

The “REGISTRATION” icon key K28 and “CANCEL” icon key K29 are displayed below the key input area II. When the icon key K28 is pressed, the diagnostic content input item can be registered. When the icon key K29 is pressed, the diagnostic content input item is non-registered (invalidated). As a result of this arrangement, when the diagnostic mode is selected, the “Registration 2—Item 1” diagnostic content input item can be registered or non-registered on the diagnostic content input screen P22.

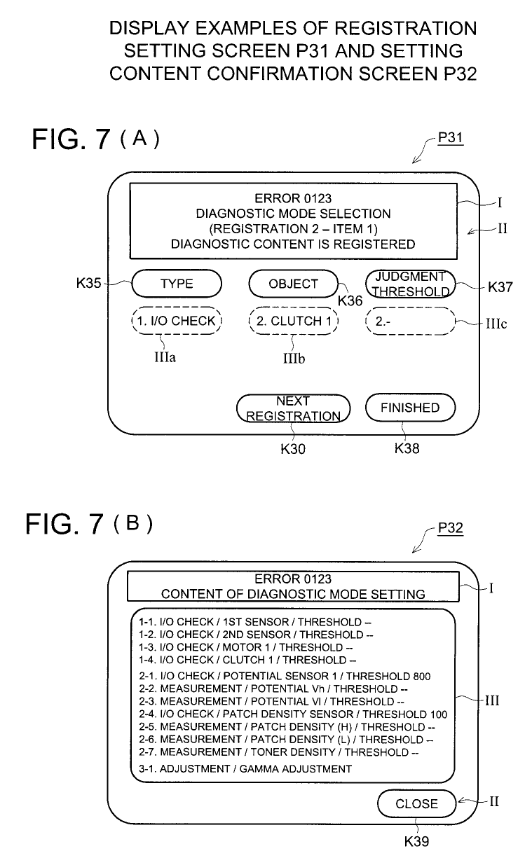

FIGS. 7 (A) and (B) are diagram showing the display example of a registration setting screen P31 and a Setting Content Confirmation Screen P32 in the error [0123].

The display is switched on the registration setting screen P31 of FIG. 7 (A) when the “REGISTRATION” icon key K28 on the diagnostic content input screen P22 of FIG. 6 (B) is pressed. The registration setting screen P31 is displayed on the display panel 18 of FIG. 2.

The message area I, key input area II, and input content display areas IIIa through IIIc of the error code 0123 are separately displayed on the registration setting screen P31 of FIG. 7 (A). The message area displays the message, “Error 0123 Diagnostic Mode Selection (Registration-Item 1) Diagnostic Content Was Registered.”

The “Type” icon key K35, “Object” icon key K36 and “Judgment Threshold” icon key K37 are displayed in the key input area II in that order starting from the left of the screen. For example, in the input content display area IIIa located below, the “1. I/O Check” is displayed as an input item, in the input content display area IIIb, the “2. clutch 1” is displayed, in the input content display area IIIc, the “2.—” is displayed.

The “Next Registration” icon key K30 and “Finished” icon key K38 are displayed below the key input area II. When the icon key K30 is pressed, the system goes to the next registration. When the icon key K38 is pressed, the aforementioned registration is finished. As a result of this arrangement, when the diagnostic mode is selected, the “Registration 2—Item 1” diagnostic content can be registered on the registration setting screen P31.

The display is switched on the error [0123] Setting Content Confirmation Screen P32 of FIG. 7 (B) when the “Finished” icon key K38 in the registration setting screen P31 of FIG. 7 (A) is pressed. The Setting Content Confirmation Screen P32 is displayed on the display panel 18 of FIG. 2.

The display contents are divided into the message area I, key input area II and setting content display area III of the error code 0123, which are separately displayed on the Setting Content Confirmation Screen P32 of FIG. 7 (B).

The title, “Error 0123 Diagnostic Mode Setting Contents”, is displayed in the message area I. The setting content display area III is arranged between the message area I and key input area II.

The “1-1. I/O Check/First Sensor/Threshold—; 1-2. I/O Check/Second Sensor/Threshold—; 1-3. I/O Check/Motor 1/Threshold—; 1-4. I/O Check/Clutch 1/Threshold—; 2-1. I/O Check/Potential Sensor/Threshold 800; 2-2. Measurement/Potential Vh/Threshold—; 2-3. Measurement/Potential Vl/Threshold—; 2-4. I/O Check/Patch Density sensor/Threshold 100; 2-5. Measurement Patch Density (H)/Threshold—; 2-6. Measurement Patch Density (L)/Threshold—; 2-7. Measurement Toner Density/Threshold—; 3-1 Adjustment/Gamma adjustment” are displayed (described) in the setting content display area III in that order downwardly from the top.

A “Close” icon key K39 appears in the key input area II below the setting content display area III. When the icon key K39 is pressed, the Setting Content Confirmation Screen P32 is closed and the system goes back to the menu screen (not illustrated). When the diagnostic mode is selected, the “Error 0123 Diagnostic Mode Setting Contents” can be confirmed on the Setting Content Confirmation Screen P32.

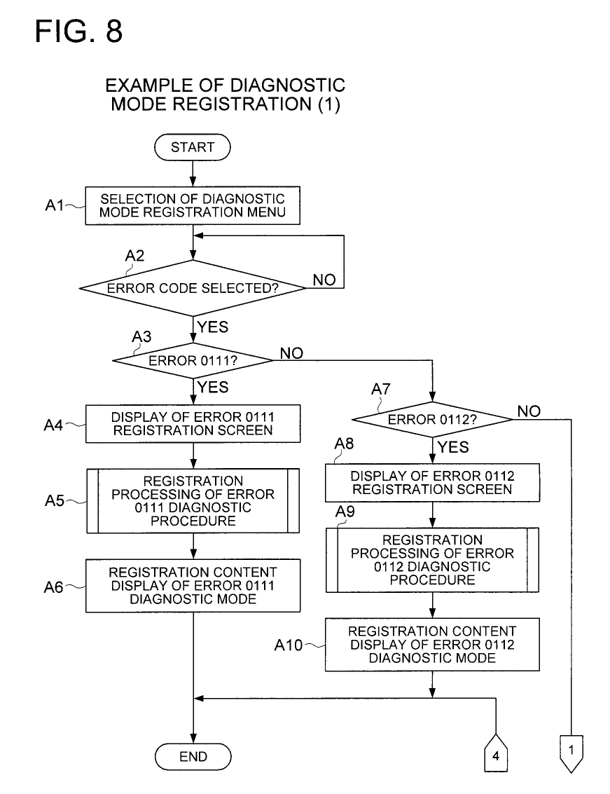

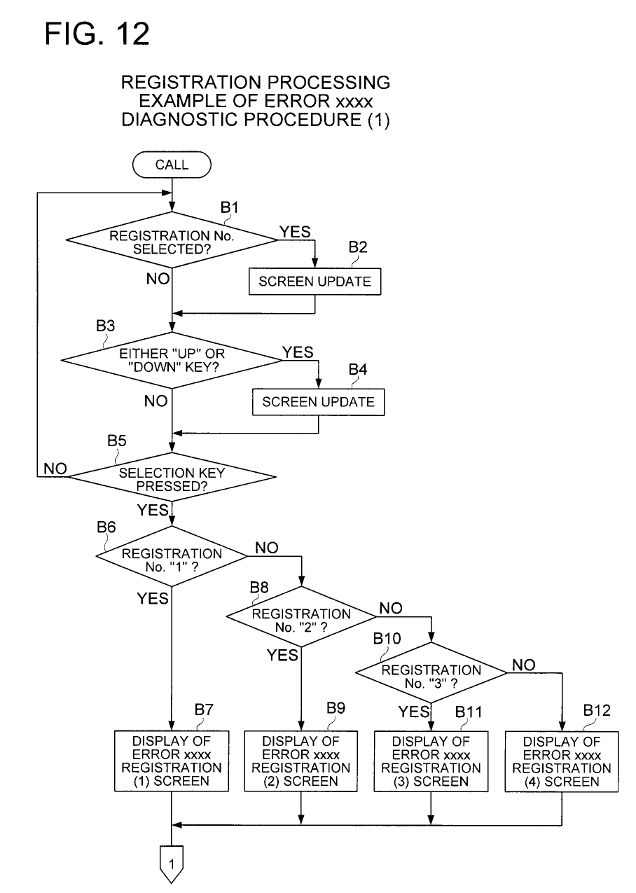

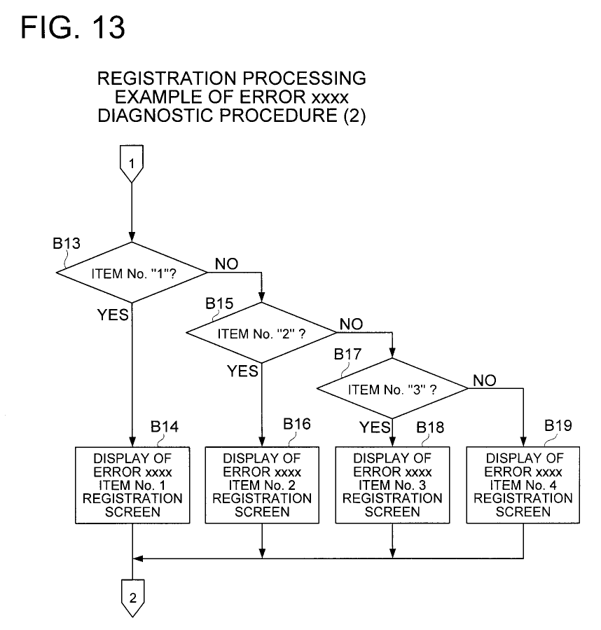

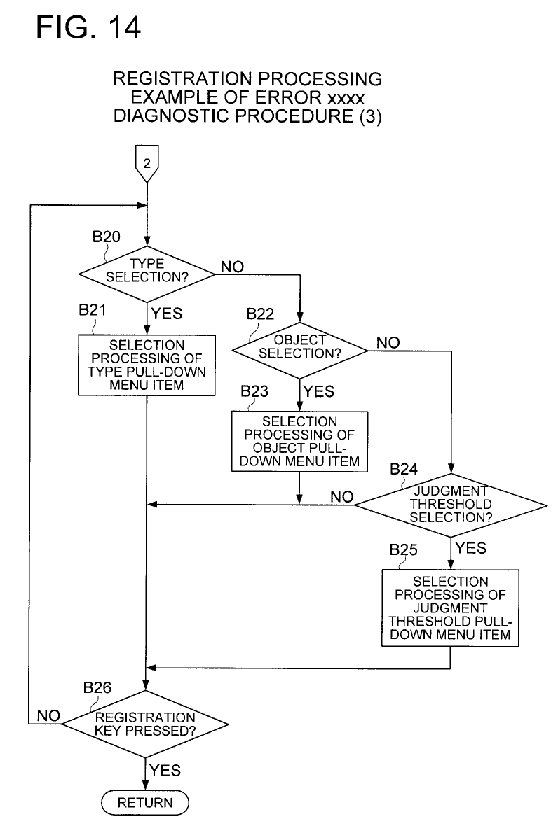

Referring to FIGS. 8 through 14, the following describes an example of the diagnostic mode registration in the color copier 100. FIGS. 8 through 11 are flow charts showing an example of the diagnostic mode registration (1 through 4), while FIGS. 12 through 14 are the flow chart showing an example of processing registration in the error xxxx diagnostic procedure (1 through 3).

In this example, the user operates the icon key of the display panel 18 or the key input device 16 to edit the information on diagnostic mode (hereinafter referred to as “diagnostic program DPx”) and/or to resister it with respect to the NVRAM33. The diagnostic program DPx is registrated in response to the error code EC. The following describes the case where there are eight error codes EC of the diagnostic mode (0111, 0112, 0115, 0121, 0122, 0123, 0124, 0125), four registered diagnostic objects and four diagnostic items.

The “DIAGNOSTIC MODE REGISTRATION MENU” is selected on the menu selection screen (not illustrated) in the Step A1 of the flow chart FIG. 8 wherein the aforementioned conditions are used as registration conditions. Then the error code selection screen P11 of FIG. 5 (A) appears on the display panel 18. In the Step A2, the CPU 55 waits for the error code to be selected. In this case, the user presses one of the icon keys K11 through K18 of error 0111, error 0112, error 0115, error 0121, error 0122, error 0123, error 0124 and error 0125 on the error code selection screen P11, thereby selecting the error code EC.

If the user presses the icon key K20 in this case, the display on a screen of the level lower than the error code selection screen P11, for example, the registration item selection screen P12 is updated. If any one of the error codes EC has been selected, the system goes to Step A3. For example, if the error 0111 has been selected as an error code EC, the system goes to the Step A4, and the CPU 55 controls the display panel 18 so that the error 0111 registration screen appears. After that, the system goes to the Step A5, and the CPU 55 executes the process of registration of the error 0111 diagnostic procedure.

For example, the subroutine of FIG. 12 is called and the CPU 55 branches the control in the Step B1 according to whether the registration number is selected or not. In this case, the user selects any one of the icon keys K21 through K24 on the registration item selection screen of FIG. 5 (B), thereby selecting the registration numbers “1” through “4”.

If the registration number has been selected, the CPU 55 controls the display panel 18 in Step B2 and updates the screen. If the screen registration number has not been selected, the system goes to the Step B3, and branches the control according to whether the priority setting is present or not. The “UP” icon key K26 or “DOWN” icon key K27 is operated for priority setting. For example, steps are taken to input and register the order of priority for implementing the diagnostic mode as exemplified by the image forming unit 81, image forming drive unit 82, laser unit 83, or sheet conveying unit 84 wherein the error code EC is associated with the diagnostic program DPx.

When the “UP” icon key K26 or “DOWN” icon key K27 has been pressed, the system proceeds to Step B4 and the CPU 55 controls the display panel 18 so that the screen is updated. When neither the “UP” icon key K26 nor “DOWN” icon key K27 is pressed, the system goes to the Step B5 wherein the control is branched according to whether any one of the icon keys K19 through K27 has been pressed or not. If none of the icon keys K19 through K27 have been pressed, the system goes back to the Step B1 and the aforementioned procedure is repeated.

If any one of the icon keys K19 through K27 has been pressed, the system goes to the Step B6 to branch the control according of whether the registration number=“1” or other number has been selected. When the registration number=“1” has been selected, the system goes to the Step B7, and the error xxxx registration (1) screen appears. The xxxx contains description of any one of eight numbers—error 0111, 0112, 0115, 0121, 0122, 0123, 0124 or 0125.

If the registration number other than number=“1” has been selected in the Step B6, the system goes to the Step B8 to branch the control according to whether the registration number=“2” or other number has been selected. If the registration number=“2” has been selected, the system goes to the Step B9 wherein the error xxxx registration (2) screen is displayed. The xxxx contains description of any one of eight numbers—error 0111, 0112, 0115, 0121, 0122, 0123, 0124 or 0125. For example, when the user has selected the registration number “2” icon key K22 on the registration item selection screen P12 of FIG. 5 (B), or has pressed the “SELECT” icon key K25, the display is switched over to the diagnostic mode selection (registration 2) screen P21 of FIG. 6 (A).

When the registration number other than number=“1” and “2” has been selected in the Step B8, the system goes to the Step B10, wherein control is branched according to whether registration number=“3” or any other number has been selected. If the registration number=“3” has been selected, the system goes to the Step B11 and the error xxxx registration (3) screen appears. The xxxx contains the description of any one of the eight error numbers—error 0111, 0112, 0115, 0121, 0122, 0123, 0124 or 0125.

If the registration number other than number=“1”, “2” and “3” has been selected in the Step B10, namely, if the registration number=“4” has been selected, the system goes to the Step B12 wherein the error xxxx Registration (4) screen appears. The xxxx contains the description of any one of the eight error numbers—error 0111, 0112, 0115, 0121, 0122, 0123, 0124 or 0125.

Then the system goes to the Step B13, wherein the control is branched according to whether Item number=“1” or any other number has been selected in the Step B13. In this case, the user presses any one of the icon keys K31 through K34 to select any one of the “ITEM 1” through “ITEM 4”.

When the Item number=“1” has been selected, the system goes to the Step B14, and the error xxxx item (1) registration screen appears. The xxxx contains the description of any one of the eight error numbers—error 0111, 0112, 0115, 0121, 0122, 0123, 0124 or 0125.

When the item number other than number=“1” has been selected in the Step B13, the system goes to the Step B15, wherein control is branched according to whether the Item number=“2” or any other number has been selected. If the Item number=“2” has been selected, the system goes to the Step B16 and the error xxxx item (2) registration screen appears. The xxxx contains the description of one of the eight error numbers—error 0111, 0112, 0115, 0121, 0122, 0123, 0124 or 0125 having been selected in the Step A2.

When the item number other than number=“1” and “2” has been selected in the Step B15, the system goes to the Step B17, wherein control is branched according to whether the Item number=“3” or any other number has been selected. If the Item number=“3” has been selected, the system goes to the Step B18 and the error xxxx item (3) registration screen appears. The xxxx contains the description of one of the aforementioned eight error numbers—error 0111, 0112, 0115, 0121, 0122, 0123, 0124 or 0125.

When the item number other than number=“1”, “2” and “3”, namely, item number=“4” has been selected in the Step B17, the system goes to the Step B19, and the error xxxx item (4) registration screen appears. The xxxx contains the description of one of the aforementioned eight error numbers—error 0111, 0112, 0115, 0121, 0122, 0123, 0124 or 0125.

Then the system goes to the Step B20, and branches the control according to whether the “Type” icon key K35 has been selected or not. In this case, the “Type” icon key K35 appears on the diagnostic content input screen P22 of FIG. 6 (B).

When the “Type” icon key K35 has been selected, the system goes to the Step B21, wherein the Type pull-down menu item is selected. The input item appears in the input content display area IIIa located below the icon key K35 of FIG. 6 (B). The “1. I/O Check; 2. Image Output; 3. Comment Input . . . ” together with the “pull-down menu” character information is displayed as the input item.

After that, the system goes to the Step B26. If the “Type” icon key K35 is not selected, the system goes to the Step B22, wherein the control is branched according to whether the “Object” icon key K36 has been selected or not. The “Object” icon key K36 appears on the diagnostic content input screen P22 of FIG. 6 (B).

When the “Object” icon key K36 has been selected, the system goes to the Step B23, wherein the object pull-down menu item is selected. In this case, the input item appears on the input content display area IIIb located below the icon key K36. The “1. Motor 1; 2. Clutch 1; 3. Sensor 1; . . . ” together with the “pull-down menu” character information is displayed as the input item. After that, the system goes to the Step B26.

If the “Object” icon key K36 is not selected in the Step B22, the system goes to the Step B24, wherein the control is branched according to whether the “Judgment Threshold” icon key K37 has been selected or not. The “Judgment Threshold” icon key K37 appears on the diagnostic content input screen P22 of FIG. 6 (B).

When the “Judgment Threshold” has been selected, the system goes to the Step B25, wherein the judgment threshold pull-down menu item is selected. The input item appears below the icon key K37. The “1. Range Specification 1; 2.—. . . ” together with the “pull-down menu” character information appears as an input item.

After that, the system goes to the Step B26, wherein the control is branched according to whether the “REGISTRATION” icon key K28 has been pressed or not. When the aforementioned icon key K28 is not pressed, the system goes back to the Step B20. For example, in the case of error 0123, the display of the diagnostic content input screen P22 shown in FIG. 6 (B) continues. When the “REGISTRATION” icon key K28 has been pressed, the system goes back to the Step A5 of the main routine shown in FIG. 8. After that, the system goes to the Step A6, wherein the registration contents of the error 0111 diagnostic mode are displayed. In the examples of FIGS. 7 (A) and 7 (B), the registration contents of the error 0123 diagnostic mode are shown.

If an error other than the error 0111 is selected in the aforementioned Step A3, the system goes to the Step A7, wherein a decision step is taken to determine if the error 0112 has been selected or not. When the error 0112 has been selected as the error code EC, the system goes to the Step A8, wherein the error 0112 registration screen appears. After that, the system goes to the Step A9, wherein the error 0112 diagnostic procedure is registered (FIGS. 12 through 14). Then the system goes back to the Step A9 of the main routine shown in FIG. 8. After that, the system goes to the Step A10, wherein the registration contents of the error 0112 diagnostic mode are displayed (FIGS. 7 (A) and 7 (B)).

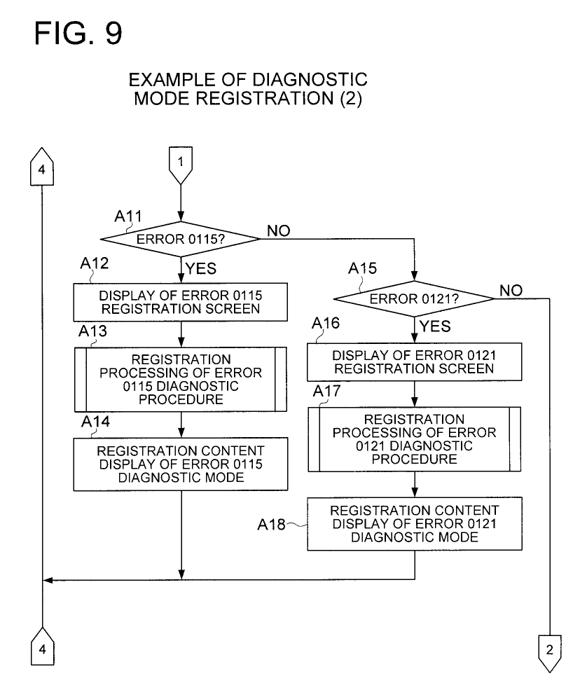

If an error other than the error 0111 and error 0112 has been selected in the Step A7, the system goes to the Step A11, wherein a decision step is taken to determine if the error 0115 has been selected or not. If the error 0115 has been selected as an error code EC, the system goes to the Step A12, wherein the error 0115 registration screen is displayed. After that, the system goes to the Step A13, wherein the error 0115 diagnostic procedure is registered (FIGS. 12 through 14). After that, the system goes to the Step A13 of the main routine shown in FIG. 9. Then the system goes back to the Step A14, wherein the registration contents of the error 0115 diagnostic mode is displayed (FIGS. 7 (A) and 7 (B)).

If an error other than the error 0111, error 0112 and error 0115 has been selected in the Step A11, the system goes to the Step A15, wherein a decision step is taken to determine if the error 0121 has been selected or not. If the error 0121 is selected as an error code EC, the system goes to the Step A16, wherein the error 0121 registration screen is displayed. Then the system goes to the Step A17, wherein the error 0121 diagnostic procedure is registered (FIGS. 12 through 14). After that, the system goes back to the Step A17 of the main routine of FIG. 9. Then it goes to the Step A18, wherein the registration contents of the error 0121 diagnostic mode appear (FIGS. 7 (A) and 7 (B)).

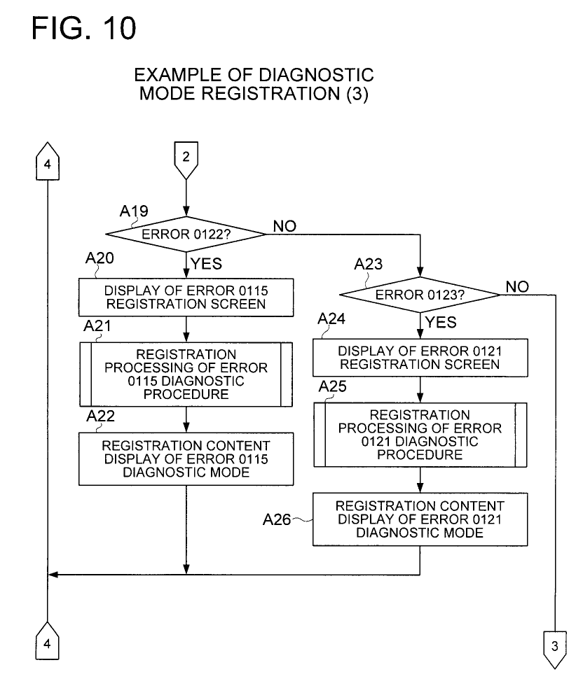

If an error other than the error 0111, error 0112, error 0115 and error 0121 has been selected in Step A15, the system goes to the Step A19, wherein a decision step is taken to determine if the error 0122 has been selected or not. If the error 0122 is selected as an error code EC, the system goes to the Step A20, wherein the error 0122 registration screen appears. After that, the system goes to the Step A21, wherein the error 0122 diagnostic procedure is registered (FIGS. 12 through 14). After that, the system goes back to the Step A21 of the main routine of FIG. 10. Then it goes to the Step A22, wherein the registration contents of the error 0122 diagnostic mode is shown (FIGS. 7 (A) and 7 (B)).

Further, if an error other than error 0111, error 0112, error 0115, error 0121 and error 0122 has been selected in the Step A19, the system goes to the Step A23, wherein a decision step is taken to determine if the error 0123 has been selected. When the error 0123 has been selected as the error code EC, the system goes to the Step A24, wherein the error 0123 registration screen is displayed. Then the system goes to the Step A25, wherein error 0123 diagnostic procedure is registered (FIGS. 12 through 14). It then goes back to the Step 25 of the main routine of FIG. 10. After that, the system goes to the Step A26, wherein the registration contents of the error 0123 diagnostic mode are displayed (FIGS. 7 (A) and 7 (B)).

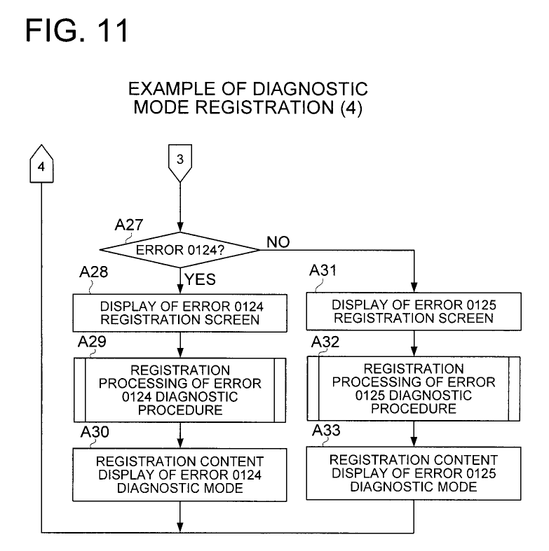

If an error other than error 0111, error 0112, error 0115, error 0121, error 0122 and error 0123 has been selected in the Step A23, the system goes to the Step A27, wherein a decision step is taken to determine if the error 0124 has been selected or not. If the error 0124 is selected as the error code EC, the system goes to the Step A28, wherein the error 0124 registration screen is shown. After that, the system goes to the Step A29, wherein the error 0124 diagnostic procedure is registered (FIGS. 12 through 14). Then the system goes back to the Step A29 of the main routine shown in FIG. 11. Then the system goes to the Step A30, wherein the registration contents of the error 0124 diagnostic mode are displayed (FIGS. 7 (A) and 7 (B)).

When the error 0125, instead of the error 0111, error 0112, error 0115, error 0121, error 0122, error 0123 and error 0124, has been selected in the Step A27, the system goes to the Step A31, wherein the error 0125 registration screen is shown. After that, the system goes to the Step A32, wherein the error 0125 diagnostic procedure is registered (FIGS. 12 through 14).

Then the system goes back to the Step A32 of the main routine of FIG. 11. After that, the system goes to the Step A33, wherein the registration contents of the error 0125 diagnostic mode are displayed (FIGS. 7 (A) and 7 (B)). This arrangement allows the setting contents in the diagnostic mode to be registered for the eight error codes EC (0111, 0112, 0115, 0121, 0122, 0123, 0124, 0125).

The setting contents in the diagnostic mode are stored in the NVRAM33. The diagnostic program DPx including the diagnostic contents such as the diagnostic Type, diagnostic object and judgment threshold can be stored not only in the NVRAM33, but also in the HDD32. In any case, the diagnostic program DPx is stored in the form associated with the diagnostic mode and error code EC. As described above, the diagnostic items for troubleshooting or diagnostic sequence can be edited and registered, whereby efficient debugging is ensured.

According to the aforementioned description of this example, the user operates the icon key of the display panel 18 and key input device 16 to edit the diagnostic program DPx, and/or the result is registered for the NVRAM33. Without being restricted thereto, the diagnostic data Dx′=(EC+DPx) sent from the server can be downloaded via the network 39 and communication modem 19. This arrangement ensures that diagnostic program DPx downloaded from a predetermined service depot via the communication modem 19 can be edited and/or registered.

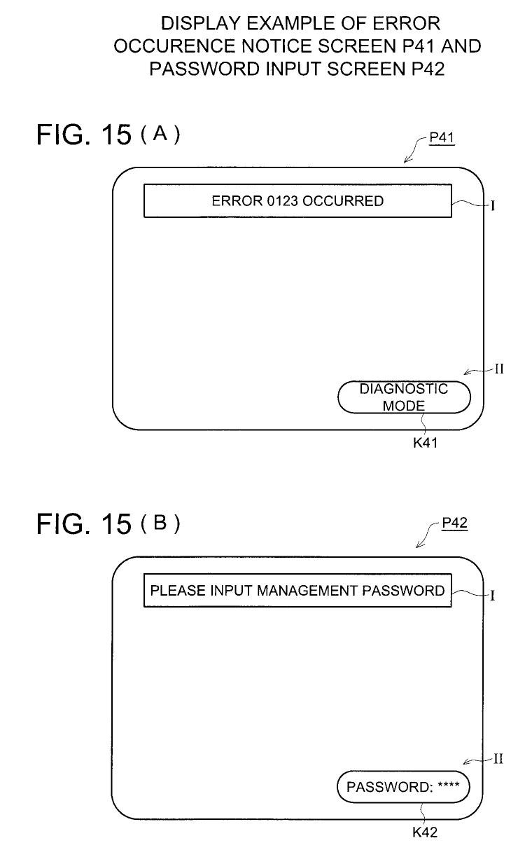

Referring to FIGS. 15 through 20, the following describes the example of executing the diagnostic mode in the color copier 100. FIGS. 15 (A) and (B) are diagrams showing the display examples of an error occurrence notice screen P41 and a password input screen P42.

The error occurrence notice screen P41 of FIG. 15 (A) is displayed on the aforementioned display panel 18 when the “Diagnostic Mode Execution Menu” has been selected on the menu selection screen (not illustrated) of the display panel 18 shown in FIG. 2. On the display panel 18, the key input icons are displayed. Various icon keys are operated from the touch panel of the display panel 18. The key input device 16 can be used to operate various types of icon keys.

On the display panel 18, the error occurrence notice screen P41 is divided into two parts for display—a message representing area (hereinafter referred to as “message area I”) and an icon key representing area (hereinafter referred to as “key input area II”)

The message area I shows that message of “The error 0123 has occurred”, for example. In the key input area II, the “Diagnostic Mode” icon key K41 appears on the lower right of the screen. If the icon key K41 is pressed, the mode is switched over to the diagnostic mode. In this manner, the diagnostic mode icon key K41 can be selected on the error occurrence notice screen P41 when the diagnostic mode is executed.

The password input screen P42 of FIG. 15 (B) is displayed on the aforementioned display panel 18 when the “Diagnostic Mode” is selected on the error occurrence notice screen P41 of FIG. 15 (A). On the password input screen P42, the message “Input the Management Password” appears, for example, in the message area I. The “PASSWORD; ****” icon key K42 is displayed in the key input area II on the lower right of the screen. The icon key K42 is provided with an area for inputting a management password. The user inputs the management password in this area. In this manner, the management password can be inputted on the password input screen P42 at the time of executing the diagnostic mode.

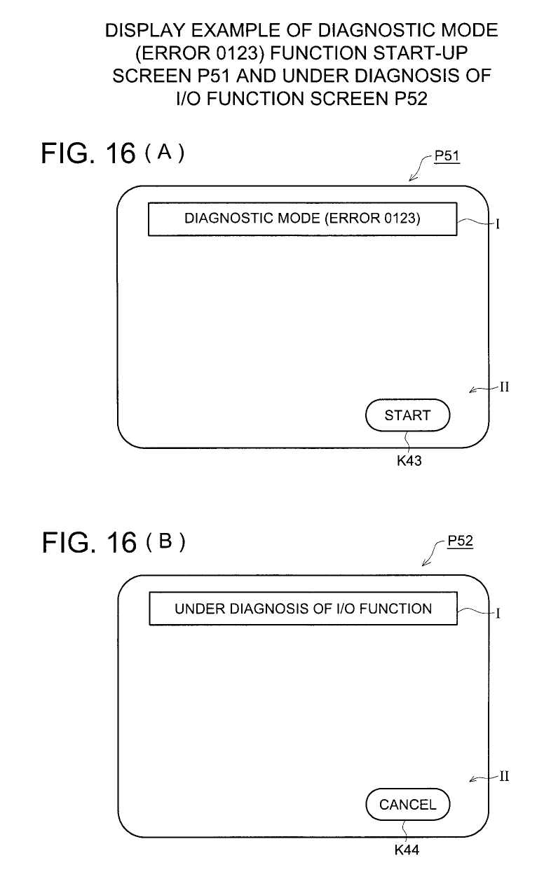

FIGS. 16 (A) and (B) are diagrams showing the display examples of a diagnostic mode (error 0123) function startup screen P51 and under-diagnosis-of-I/O function screen P52.

The diagnostic mode (error 0123) function startup screen P51 of FIG. 16 (A) is displayed on the aforementioned display panel 18 when the management password has been correctly inputted on the password input screen P42 of FIG. 15 (B) in the display panel 18 of FIG. 2. On the diagnostic mode (error 0123) function startup screen P51, the title, “Diagnostic Mode (Error 0123)”, for example, appears in the message area I. In the key input area II, the “START” icon key K43 appears on the lower right of the screen. When the icon key K43 is pressed, the diagnostic mode (error 0123) starts. In this manner, the diagnostic mode (error 0123) can be started by pressing the icon key K43 on the diagnostic mode (error 0123) function startup screen P51 at the time of executing the diagnostic mode.

The under-diagnosis-of-I/O function screen P52 of FIG. 16 (B) is displayed on the aforementioned display panel 18 by pressing the “START” on the diagnostic mode (error 0123) function startup screen P51 of FIG. 16 (A). On the under-diagnosis-of-I/O function screen P52, the title such as “Under Diagnosis of I/O Function” is displayed in the message area I. In the key input area II, the “CANCEL” icon key K44 appears on the lower right of the screen. In this example, the I/O function diagnosis can be cancelled in the middle of operation by pressing the icon key K44 on the under-diagnosis-of-I/O function screen P52 at the time of executing the diagnostic mode.

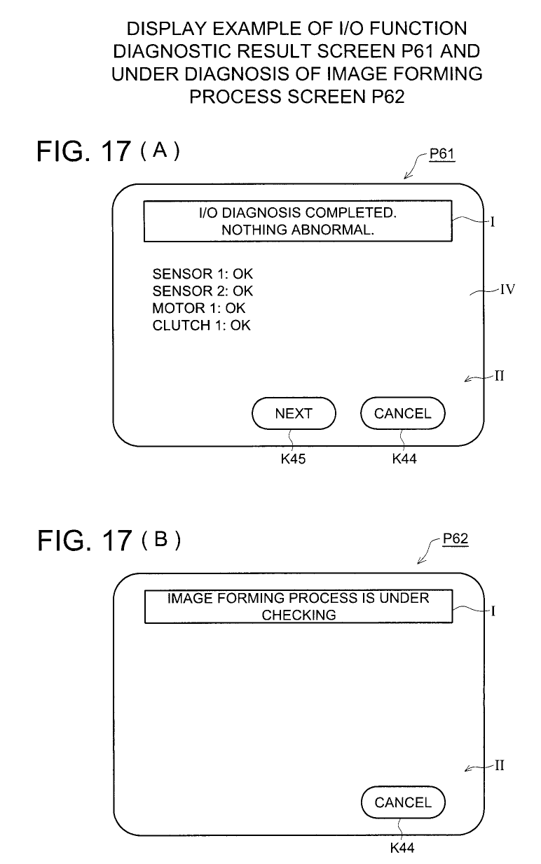

FIGS. 17 (A) and (B) are diagrams showing the display examples of a I/O function diagnostic result screen P61 and under-diagnosis-of-image-forming-process screen P62.

The I/O function diagnostic result screen P61 of FIG. 17 (A) is displayed on the aforementioned display panel 18 when the I/O Function Diagnosis has completed on the under-diagnosis-of-I/O function screen P52 of FIG. 16 (B) on the display panel 18 of FIG. 2. On the I/O function diagnostic result screen P61, the message, “I/O DIAGNOSIS COMPLETED, NOTHING ABNORMAL” appears in the message area I.

In this example, the diagnostic result display area IV is provided between the message area I and key input area II. In the diagnostic result display area IV, the “SENSOR 1: OK”, “SENSOR 2: OK”, “MOTOR 1: OK”, “CLUTCH 1: OK” is displayed as a diagnostic result in the diagnostic mode (error 0123).

The “NEXT” icon key K45 and “CANCEL” icon key K44 are displayed below the diagnostic result display area IV. The system goes to the next diagnostic item by pressing the icon key K45. In this manner, the result of I/O function diagnosis can be verified on the I/O function diagnostic result screen P61.

The under-diagnosis-of-image-forming-process screen P62 of FIG. 17 (B) is displayed on the aforementioned display panel 18 by pressing the “NEXT” icon key K45 on the I/O function diagnostic result screen P61 of FIG. 17 (A). On the under-diagnosis-of-image-forming-process screen P62 the title, “IMAGE FORMING PROCESS IS UNDER CHECKING”, for example, is displayed in the message area I. In the key input area II, the “CANCEL” icon key K44 appears on the lower right of the screen. In this example, image forming process diagnosis can be cancelled in the middle of the operation by pressing the icon key K44 on the under-diagnosis-of-image-forming-process screen P62 at the time of executing the diagnostic mode.

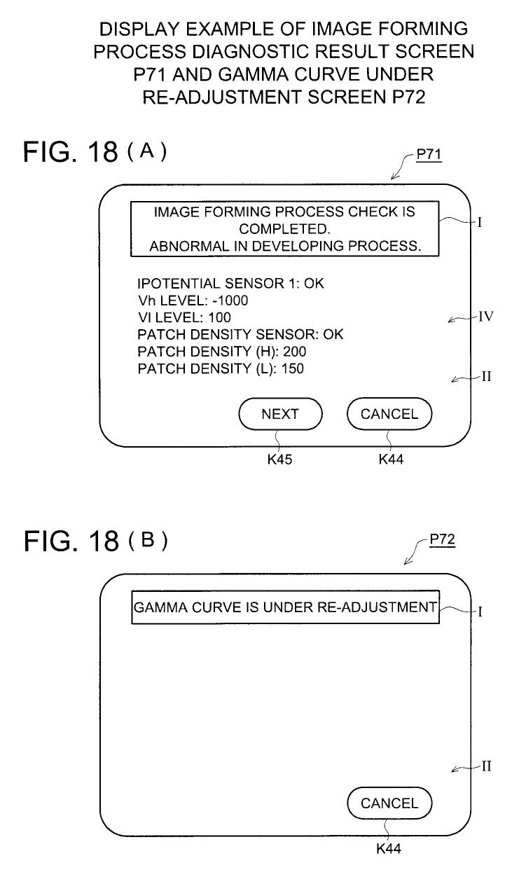

FIGS. 18 (A) and (B) are diagrams showing the display examples of image forming process check result screen P71 and gamma-curve-under-readjustment screen P72.

The image forming process check result screen P71 of FIG. 18 (A) is displayed on the aforementioned display panel 18 when the image forming process diagnosis has completed on the under-diagnosis-of-image-forming-process screen P62 of FIG. 17 (B) on the display panel 18 of FIG. 2. On the image forming process check result screen P71, the message, “IMAGE FORMING PROCESS CHECK IS COMPLETED. ABNORMAL IN DEVELOPING PROCESS”, for example, appears in the message area I.

In this example, in the diagnostic result display area IV provided between the message area I and key input area II, “POTENTIAL SENSOR 1: OK”, “Vh LEVEL: −1000”, “Vl LEVEL: 100”, “PATCH DENSITY SENSOR: OK”, “PATCH DENSITY (H): 200” and “PATCH DENSITY (L): 150” are displayed as an image processing check result in the diagnostic mode (error 0123).

The “NEXT” icon key K45 and “CANCEL” icon key K44 appear below the diagnostic result display area IV. The system goes to the next diagnostic items by pressing the icon key K45. This arrangement allows the image processing check result to be confirmed on the image forming process check result screen P71.

The gamma-curve-under-readjustment screen P72 of FIG. 18 (B) is displayed on the aforementioned display panel 18 by pressing the “NEXT” icon key K45 on the image forming process check result screen P71 of FIG. 18 (A). On the gamma-curve-under-readjustment screen P72, the title, “GAMMA CURVE IS UNDER RE-ADJUSTMENT” appears in the message area I. In the key input area II, the “CANCEL” icon key K44 is shown on the lower right of the screen. In this example, gamma curve re-adjustment can be cancelled in the middle of the operation by pressing the icon key K44 on the gamma-curve-under-readjustment screen P72 at the time of executing the diagnostic mode.

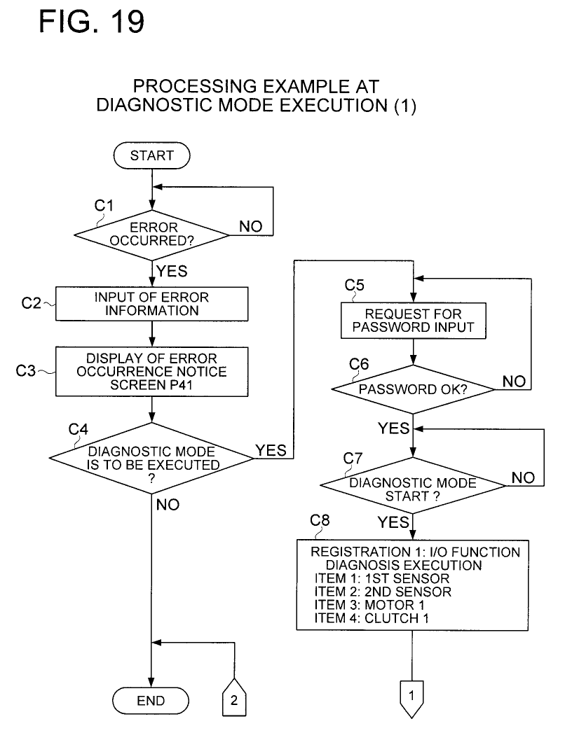

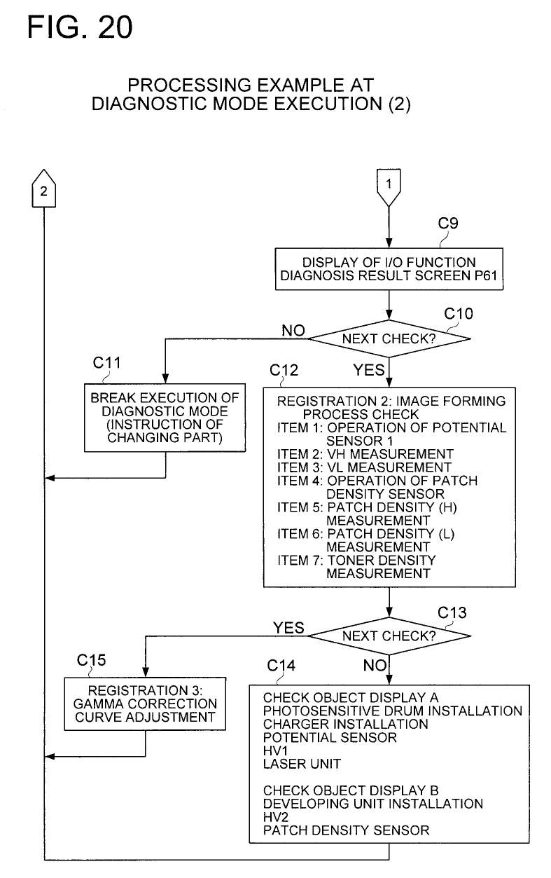

FIGS. 19 and 20 are flow charts showing an example of processing in execution of diagnostic mode (parts 1 and 2) in the color copier 100.

In the NVRAM33 of this color copier 100, the error codes EC on the errors that are anticipated in each of the image forming units 81, image forming drive unit 82, laser unit 83, sheet conveying unit 84 and others inside the copier body are associated with the diagnostic items for diagnosing the statuses of the image forming units 81, image forming drive unit 82, laser unit 83 and sheet conveying unit 84 when an error has occurred. The diagnostic program DPx is stored as the data on the diagnostic mode. The diagnostic items incorporate the diagnostic procedure.

This example refers to the case wherein the error 0123 diagnostic mode is registered. Three registrations—Registration 1 through 3—are set to the diagnostic object, and seven items—ITEMS 1 through 7—are registered as diagnostic items.

Using the aforementioned factors as diagnostic mode conditions, the error detecting section 90 of FIG. 2 monitors occurrence of an error in the Step C1 of the flow chart of FIG. 19. In the error detecting section 90, various signals such as detection signals S#1 and S#2, voltage detection signals HV1 and HV2, timing detection signal Sst, position detection signal Ssp, beam detection signal Sbd, paper detection signal Ssz obtained from various sensors such as sensors SV1 and SV2, sensor #1, sensor #2 and sensor SZ arranged on each of the image forming unit 81, image forming drive unit 82, laser unit 83 and sheet conveying unit 84 are compared with the anticipated values of various types of the preset signals, whereby a decision step is taken to determine if an error has occurred or not.

When various signals such as detection signals S#1, S#2, HV1, HV2, Sst, Ssp, Sbd and Ssz have failed to meet the expected values, the error detecting section 90 determines that an error has occurred to the aforementioned unit (“ERROR”). When an error has occurred in this example, the error detecting section 90 analyzes the error. For example, the error code EC=“error 0123” is outputted to the CPU 55 as error information.

In the Step C2, the CPU 55 inputs the error code EC=“error 0123” through the error detecting section 90. After that, the CPU 55 controls the display panel 18 in the Step C3 so that the error occurrence notice screen P41 of FIG. 15 (A) appears. On the error occurrence notice screen P41, a message—“Error 0123 Has Occurred”—appears in the message area I. The “Diagnostic Mode” icon key K41 is shown on the lower right of this screen.

In the Step C4, the CPU 55 branches the control, in response to the user's instruction, according to whether the diagnostic mode is executed or not. In this case, the mode shifts to the diagnostic mode when the user has pressed the icon key K41.

At the time of executing the diagnostic mode, the system goes to the Step C5, and the CPU 55 executes the password input request. In this case, the message—“Input the management password.”—appears in the message area I of the password input screen P42 of FIG. 15 (B). The “PASSWORD; ****” icon key K42 is shown on the lower right of the screen. The user inputs the management password to this area.

In the Step C6, the CPU 55 verifies the password. The password is registered in advance. Using this as an anticipated value, the CPU 55 takes the step of comparison and verification. If the password fails to match, the system goes back to the Step C5 to repeat the procedure of verifying the password.

When the password has been verified as being matched, the system goes to the Step C7, wherein the CPU 55 control the display panel 18 so that the title—“Diagnostic Mode (Error 0123)”—is displayed in the message area I of the diagnostic mode (error 0123) function startup screen P51 of FIG. 16 (A). On this screen, the CPU 55 waits for the diagnostic mode startup instruction. The “START” icon key K43 appears on the lower right of the diagnostic mode (error 0123) function startup screen P51. If the user has pressed the icon key K43, the diagnostic mode (error 0123) starts up.

If there is startup instruction, the system goes to the Step C8, wherein the CPU 55 executes the Registration 1. In this case, the CPU 55 controls the display panel 18 so that the under-diagnosis-of-I/O function screen P52 of FIG. 16 (B) is shown. The title—“Under Diagnosis of I/O Function”—is displayed in the message area I. The “CANCEL” icon key K44 appears on the lower right of the screen.

The content of processing the “Registration 1” is the I/O Function Diagnosis, and the CPU 55 executes this I/O Function Diagnosis. The Item 1 refers to the diagnosis of the “First Sensor 1”, the Item 2 to the diagnosis of the “Second Sensor 2”, the Item 3 to the diagnosis of the “Motor 1”, and the Item 4 to the diagnosis of the “Clutch 1”.

After that, the system goes to the Step C9, wherein the I/O function diagnostic result screen P61 is shown. In this case, the message—“I/O DIAGNOSIS COMPLETED, NOTHING ABNORMAL”—appears in the message area I of the I/O function diagnostic result screen P61 of FIG. 17 (A). The “SENSOR 1: OK”, “SENSOR 2: OK”, “MOTOR 1: OK”, and “CLUTCH 1: OK” are displayed in the diagnostic result display area IV as the diagnostic result in the diagnostic mode (error 0123). The “NEXT” icon key K45 and “CANCEL” icon key K44 appear below the diagnostic result display area IV. The system goes to the next diagnostic items when icon key K45 has been pressed.

Then the system goes to the Step C10, wherein the control is branched according to a decision step to determine if the next check is to be performed or not. For example, when the cause for the error has been clarified and the object parts have to be replaced without the need of conducting the next check, the system goes to the Step C11, wherein the diagnostic mode execution is broken to prompt the user to replace parts. This terminates the processing in the diagnostic mode.

If the cause for the error has not yet been clarified in the Step C10, the system goes to the Step C12 to perform the next check. The CPU 55 executes registration 2 in the Step C12. The content of the “Registration 2” is to check the process of image formation. The CPU 55 checks the process of image formation. The item 1 is to check the “Operation of Potential Sensor”, the item 2 is to measure the voltage Vh, the item 3 is to measure the voltage Vl, the item 4 is to check the operation of patch density sensor, the item 5 is to measure the patch density (H), the item 6 is to measure the patch density (L), and the item 7 is to measure the toner density. In this case, the title—“IMAGE FORMING PROCESS IS UNDER CHECKING”—is indicated in the message area I of the under-diagnosis-of-image-forming-process screen P62 of FIG. 17 (B). The “CANCEL” icon key K44 is displayed on the lower right of the screen.

After that, the system goes to the Step C13 and branches the control according to whether the next check is to be performed or not. If the “Next Inspection Not Performed” has been selected, the system goes to the Step C14, wherein a process of display is executed. The process of display includes the Check Object Display #A and Display #B. In the Check Object Display #A, the CPU 55 allows the display panel 18 to display the installation condition of the photoreceptor, charging pole, potential sensor, transfer device (HV1), and laser unit. In the Check Object Display #B, the CPU 55 allows the display panel 18 to display the installation conditions of the development unit, charging device (HV2) and patch density sensor.

On the image forming process check result screen P71 of FIG. 18 (A) in this case, the check result of the installation conditions appears on the aforementioned display panel 18 upon completion of the image forming process diagnosis. The message “IMAGE FORMING PROCESS CHECK IS COMPLETED. ABNORMAL IN DEVELOPING PROCESS” is displayed in the message area I of the image forming process check result screen P71.

The “POTENTIAL SENSOR 1: OK”, “Vh LEVEL: −1000”, “Vl LEVEL: 100”, “PATCH DENSITY SENSOR: OK”, “PATCH DENSITY (H): 200” and “PATCH DENSITY (L): 150” are displayed in the diagnostic result display area IV as the image processing check result in the diagnostic mode (error 0123). The “NEXT” icon key K45 and “CANCEL” icon key K44 appear below the diagnostic result display area IV. The system goes to the diagnostic item when the icon key K45 is pressed.

When the “The Next Check is Performed” is selected in the Step C13, the system goes to the Step C15 and the CPU 55 executes the Registration 3. In this case, the CPU 55 controls the display panel 18 to display the gamma-curve-under-readjustment screen P72 of FIG. 18 (B). On the gamma-curve-under-readjustment screen P72, the title—“GAMMA CURVE IS UNDER RE-ADJUSTMENT”—, for example, is indicated in the message area I. The “CANCEL” icon key K44 is displayed on the lower right of the screen. The CPU 55 outputs the control signal S81 to the image forming unit 81, and the control signal S82 to the image forming drive unit 82, whereby the gamma correction curve is adjusted (Registration 3). This arrangement permits execution of the diagnostic mode related to error code EC=error 0123.

As described above, the color copier 100 as an embodiment of the present invention ensures that the NVRAM33 registers the diagnostic mode. For example, the key input device 16 is operated to edit and/or register the diagnostic program DPx to be stored in the NVRAM33. The NVRAM33 stores the diagnostic mode and error code EC in the form associated with each other. Based on this assumption, the error detecting section 90 detects an error inside the aforementioned copier 100 when an error has occurred, and the error code EC is outputted to the CPU 55.

Upon receipt of from the NVRAM33 the diagnostic mode corresponding to the error code EC inputted from the error detecting section 90, the CPU 55 executes troubleshooting (problem solution and recovery) of the aforementioned copier 100. In this example, the operation conditions of various sensors are subjected to self-diagnosis, and the diagnostic result is displayed on the display panel 18, whereby quick identification of faulty positions is ensured.

Thus, when an error has occurred, troubleshooting can be provided under the initiative of the aforementioned copier 100. Needless to say, troubleshooting can be provided by the CPU 55 in response to the user's instruction. When this arrangement is adopted, troubleshooting of the aforementioned copier 100 can be performed continuously in the diagnostic mode emitted and registered even after the error has occurred.

Moreover, effective identification of faulty positions and problem solution can be achieved, and the work procedure (flow) based on the diagnostic program DPx can be edited. Accordingly, troubleshooting can always be performed according to the work procedure in response to the most updated information and the characteristics inherent to the copier body (machine).

If the point that had not been assumed in the beginning has been found out to be related to the problem, that diagnostic item is added. This arrangement ensures smooth and easy solution of a similar problem even when such a similar problem has occurred on a later date or the operator has been replaced by another person. Further, the diagnostic information is collected at a support center and is distributed via the network, whereby an effective solution of the problem of other machines is ensured.

The aforementioned Example refers to the cases wherein the user operates the icon key of the display panel 18 and key input device 16 so that the diagnostic program DPx is edited and/or registered in the NVRAM33, or wherein the diagnostic data Dx′=(EC+DPx) distributed from the server is received via the network 39 and communication modem 19. Without the present invention being restricted thereto, it is also possible to arrange such a configuration that, when the diagnostic data Dx′=(EC+DPx) registered in the NVRAM33 or HDD32 has been updated, registration contents are sent to a predetermined service depot via the communication modem 19 and network 39. When this arrangement is used, the diagnostic program DPx related to updating is shared or can be shared among a plurality of copiers and multifunction machines connected to the network 39.

As can be understood from the description above, an embodiment of the present invention is an image forming apparatus includes: a registration section which registers information on a diagnostic mode, where an operation mode to diagnose inside the image forming apparatus based on error information is assumed to be the diagnostic mode; an error detecting section which detects an error in the apparatus and outputs error information; and a control section which, when the error detecting section outputs error information, receives the information on the diagnostic mode corresponding to the error information from the registration section, and executes problem solution and recovery of the apparatus.

In this image forming apparatus, the registration section registers information on the diagnostic mode. For example, the input section is operated so that the information on the diagnostic mode are edited and/or registered in the storage section. The storage section stores the diagnostic mode correlated to the error information. This is based on the understanding that the error detecting section detects an error in this apparatus and the error information is outputted to the control section. The control section inputs error information from the error detecting section. Receiving the information on the diagnostic mode corresponding to this error information from the registration section, the control section executes solution of the problem with this apparatus so as to recover the apparatus from error.

Thus, in the event of an error, the aforementioned arrangement permits troubleshooting to be performed predominantly under the initiative of this apparatus. This arrangement ensures the troubleshooting of this apparatus to be carried out on a continuous basis in the diagnostic mode edited and registered in conformity to this apparatus even after the occurrence of the error.

Another embodiment of the image forming apparatus of the present invention includes:

a storage section which correlates and stores the error information and the information on the diagnostic mode; and

an input section which is operated so that the information on diagnostic mode is edited and/or registered in the storage section.

In the image forming apparatus, the registration section sets the priority of the diagnostic mode and registers it, and the control section executes the diagnostic mode according to the priority.

The image forming apparatus is provided with a display section for displaying the result of the diagnostic mode having been executed.

The image forming apparatus has a communication section, which can be connected to the network, for receiving information on the diagnostic mode to be registered in the registration section, and the apparatus updates the diagnostic mode registered in the registration section according to the information on the diagnostic mode received via the communication section.

The image forming apparatus has a communication section, which can be connected to the network, for sending information on the diagnostic mode registered in the registration section, and sends the registered data to a predetermined site through the communication section when the diagnostic mode has been updated.

According to the embodiment the image forming apparatus has a control section for inputting the error information from the error detecting section. When an error has been detected inside the apparatus, the control section receives the information on the diagnostic mode corresponding to the error information from the registration section, and executes a process of problem solution or recovery (troubleshooting) of the present invention.

This arrangement allows the troubleshooting to be conducted under the initiative of this apparatus in the event of an error, and therefore, ensures the troubleshooting of this apparatus to be carried out in the diagnostic mode edited and registered in conformity to this apparatus on a continuous basis even after the occurrence of the error.

The present invention is preferably applied to a color printer or color copier equipped with a self-diagnostic function, or a color multifunctional peripheral having a combination of their functions.

What is claimed is:

1. An image forming apparatus comprising:
a registration section which registers information on a diagnostic mode, where an operation mode to diagnose inside the image forming apparatus based on error information is assumed to be the diagnostic mode;
an error detecting section which detects an error in the apparatus and outputs error information; and
a control section which, when the error detecting section outputs error information, receives the information on the diagnostic mode corresponding to the error information from the registration section, and executes problem solution and recovery of the apparatus.

2. The image forming apparatus of claim 1, wherein the registration section comprises:
a storage section which correlates and stores the error information and the information on the diagnostic mode; and
an input section which is operated so that the information on diagnostic mode is edited and/or registered in the storage section.

3. The image forming apparatus of claim 1, wherein the control section receives information, in which priority has been set for the diagnostic mode, from the registration section, and executes the diagnostic mode according to the priority.

4. The image forming apparatus of claim 1, further comprises a display section which displays a result of executing the diagnostic mode.

5. The image forming apparatus of claim 1, further comprising a communication section which is connectable to a network and receives information on the diagnostic mode to be registered in the registration section, wherein the registration section updates the information of the diagnostic mode registered in the registration section based on the information on the diagnostic mode received via the communication section.

6. The image forming apparatus of claim 1, further comprising a communication section which is connectable to a network and sends information on the diagnostic mode registered in the registration section, wherein when the information of the diagnostic mode is updated, the image forming apparatus sends registered data of the information on the diagnostic mode to a predetermined site through the communication section.
